(19) United States
(12) Patent Application Publication
(10) Pub. No.: US 2025/0365111 A1
(43) Pub. Date: Nov. 27, 2025

(54) BI-STATIC SENSING BEAM PAIRING IN INTEGRATED SENSING AND COMMUNICATION SYSTEMS

(71) Applicant: QUALCOMM Incorporated, San Diego, CA (US)

(72) Inventors: Hyojin LEE, San Diego, CA (US); Weimin DUAN, San Diego, CA (US); Alexandros MANOLAKOS, Athens (GR)

(21) Appl. No.: 18/872,235

(22) PCT Filed: May 24, 2023
(86) PCT No.: PCT/US2023/023381

§ 371 Date: Dec. 5, 2024

(30) Foreign Application Priority Data
Jul. 26, 2022 (GR) 20220100604

(51) Int. Cl. H04L 5/00

(52) U.S. Cl. CPC H04L 5/0051

(57) ABSTRACT

Aspects presented herein may improve the performance of a JCS system by providing various resource mapping for the sensing and communication of the JCS system. Aspects presented herein may enable a base station to use PDSCH for MIMO sensing with FDM based waveform orthogonality, and may also enable a UE to support DMRS channel estimation when PDSCH is used for MIMO sensing with FDM based waveform orthogonality. In one aspect, a UE receives a plurality of PDSCHs on a plurality of ports, each PDSCH of the plurality of PDSCHs being received through a different port of the plurality of ports, each PDSCH of the plurality of PDSCHs being received on a different set of non-overlapping REs within each RB of a set of RBs. The UE demodulates each PDSCH of a port based on DMRS received through the port.

### CROSS-REFERENCE TO RELATED APPLICATION

This application claims the benefit of Greece Patent Application No. 20220100604, entitled “BI-STATIC SENSING BEAM PAIRING IN INTEGRATED SENSING AND COMMUNICATION SYSTEMS” and filed on Jul. 26, 2022, which is expressly incorporated by reference herein in its entirety.

### TECHNICAL FIELD

The present disclosure relates generally to communication systems, and more particularly, to positioning systems involving radio frequency (RF) sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus receives a plurality of physical downlink shared channels (PDSCHs) on a plurality of ports, each PDSCH of the plurality of PDSCHs being received through a different port of the plurality of ports, each PDSCH of the plurality of PDSCHs being received on a different set of non-overlapping resource elements (REs) within each resource block (RB) of a set of RBs. The apparatus demodulates each PDSCH of a port based on demodulation reference signals (DMRS) received through the port.

In an aspect of the disclosure, a method, a computer-readable medium, and an apparatus are provided. The apparatus transmits a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs. The apparatus receives the transmitted PDSCHs reflected from one or more objects. The apparatus performs radar sensing for detecting the one or more objects based on the received reflected transmitted PDSCHs.

In an aspect of the disclosure, a method, a computer-readable medium, and an apparatus are provided. The apparatus receives a plurality of PDSCHs on a plurality of ports, each PDSCH of the plurality of PDSCHs being received through a different port of the plurality of ports, each PDSCH of the plurality of PDSCHs being received on a different RBG of a set of RBGs. The apparatus de-interleaves the received PDSCHs based on a configured radar sensing interleaving pattern. The apparatus demodulating each de-interleaved PDSCH of a port based on DMRS received through the port.

In an aspect of the disclosure, a method, a computer-readable medium, and an apparatus are provided. The apparatus interleaves a plurality of PDSCHs based on a radar sensing interleaving pattern. The apparatus transmits, to a UE, a configuration indicating the radar sensing interleaving pattern. The apparatus transmits, to the UE, the plurality of PDSCHs on a plurality of ports, each PDSCH of the plurality of PDSCHs being transmitted through a different port of the plurality of ports, each PDSCH of the plurality of PDSCHs being transmitted on a different RBG.

In an aspect of the disclosure, a method, a computer-readable medium, and an apparatus are provided. The apparatus sends, to one or more network entities, physical downlink shared channel (PDSCH) mapping information, the PDSCH mapping information corresponding to a plurality of PDSCHs on a plurality of ports and corresponding beam direction information, each PDSCH of the plurality of PDSCHs being through a different port of the plurality of ports, each PDSCH of the plurality of PDSCHs being on a different set of non-overlapping REs within each RB of a set of RBs. The apparatus receives, from the one or more network entities in response to the transmitted PDSCH mapping information, radar sensing results.

In an aspect of the disclosure, a method, a computer-readable medium, and an apparatus are provided. The apparatus sends, to one or more network entities, physical downlink shared channel (PDSCH) mapping information, the PDSCH mapping information corresponding to PDSCH interleaving information based on a radar sensing interleaving pattern and to a plurality of PDSCHs being through a different port of the plurality of ports and corresponding beam direction information, each PDSCH of the plurality of PDSCHs being on a different RBG. The apparatus receives, from the one or more network entities in response to the transmitted PDSCH interleaving information, radar sensing results.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of radar signals (e.g., radar reference signals (RRSs)) generated from a wireless device in accordance with various aspects of the present disclosure.

FIG. 6A is a diagram illustrating an example co-located and cooperative radar and communication system in accordance with various aspects of the present disclosure.

FIG. 6B is a diagram illustrating an example co-design of communication and radar system in accordance with various aspects of the present disclosure.

FIG. 7 is a diagram illustrating an example of multi-input multi-output (MIMO) radar configurations in accordance with various aspects of the present disclosure.

FIG. 8 is a diagram illustrating an example of joint MIMO sensing and communications in accordance with various aspects of the present disclosure.

FIG. 9 is a diagram illustrating an example of equidistant resource element (RE)/resource block (RB)/resource block group (RBG) level interleaving in accordance with various aspects of the present disclosure.

FIG. 10 is a diagram illustrating an example comb-type resource mapping without staggering in accordance with various aspects of the present disclosure.

FIG. 11 is a diagram illustrating an example comb-type resource mapping with staggering in accordance with various aspects of the present disclosure.

FIG. 12 is a diagram illustrating example values for frequency offset for different symbol number and/or different number of ports in accordance with various aspects of the present disclosure.

FIG. 13 is a diagram illustrating an example comb-type resource mapping without staggering in accordance with various aspects of the present disclosure.

FIG. 14 is a diagram illustrating an example comb-type resource mapping with staggering in accordance with various aspects of the present disclosure.

FIG. 15 is a diagram illustrating an example of RB/RBG-level port mapping in accordance with various aspects of the present disclosure.

FIG. 16 is a diagram illustrating an example virtual resource block (VRB)-to-PRB mapping based on rectangular interleaver with P rows in accordance with various aspects of the present disclosure.

FIG. 17 is a diagram illustrating an example system architecture for performing RF sensing via multiple base stations in accordance with various aspects of the present disclosure.

FIG. 18 is a flowchart of a method of wireless communication.

FIG. 19 is a diagram illustrating an example of a hardware implementation for an example apparatus and/or network entity.

FIG. 20 is a flowchart of a method of wireless communication.

FIG. 21 is a diagram illustrating an example of a hardware implementation for an example apparatus and/or network entity.

FIG. 22 is a diagram illustrating an example of a hardware implementation for an example apparatus and/or network entity.

### DETAILED DESCRIPTION

Aspects presented herein may improve the performance of a JCS system by providing various resource mapping for the sensing and communication of the JCS system. Aspects presented herein may enable a base station to use PDSCH for MIMO sensing with FDM based waveform orthogonality, and may also enable a UE to support DMRS channel estimation when PDSCH is used for MIMO sensing with FDM based waveform orthogonality (e.g., linking DMRS port to PDSCH based on the resource mapping to enable channel estimation for decoding).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

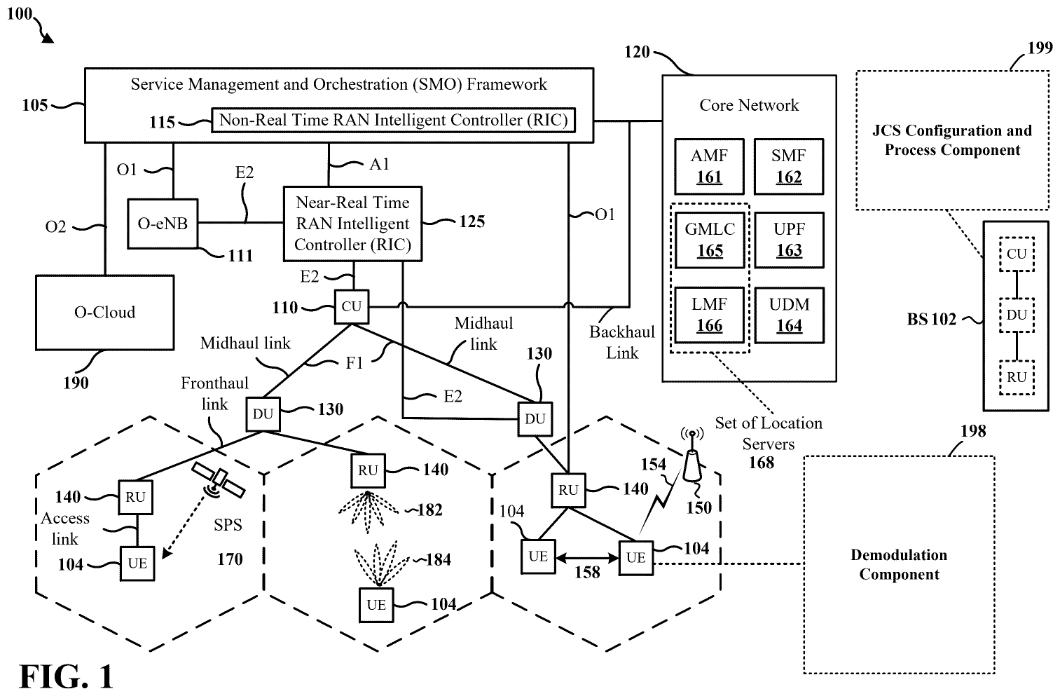

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to receive a plurality of PDSCHs on a plurality of ports, each PDSCH of the plurality of PDSCHs being received through a different port of the plurality of ports, each PDSCH of the plurality of PDSCHs being received on a different set of non-overlapping REs within each RB of a set of RBs; and demodulate each PDSCH of a port based on DMRS received through the port via the demodulation component 198. In certain aspects, the base station 102 may be configured to transmit a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs; receive the transmitted PDSCHs reflected from one or more objects; and perform radar sensing for detecting the one or more objects based on the received reflected transmitted PDSCHs via the JCS configuration and process component 199.

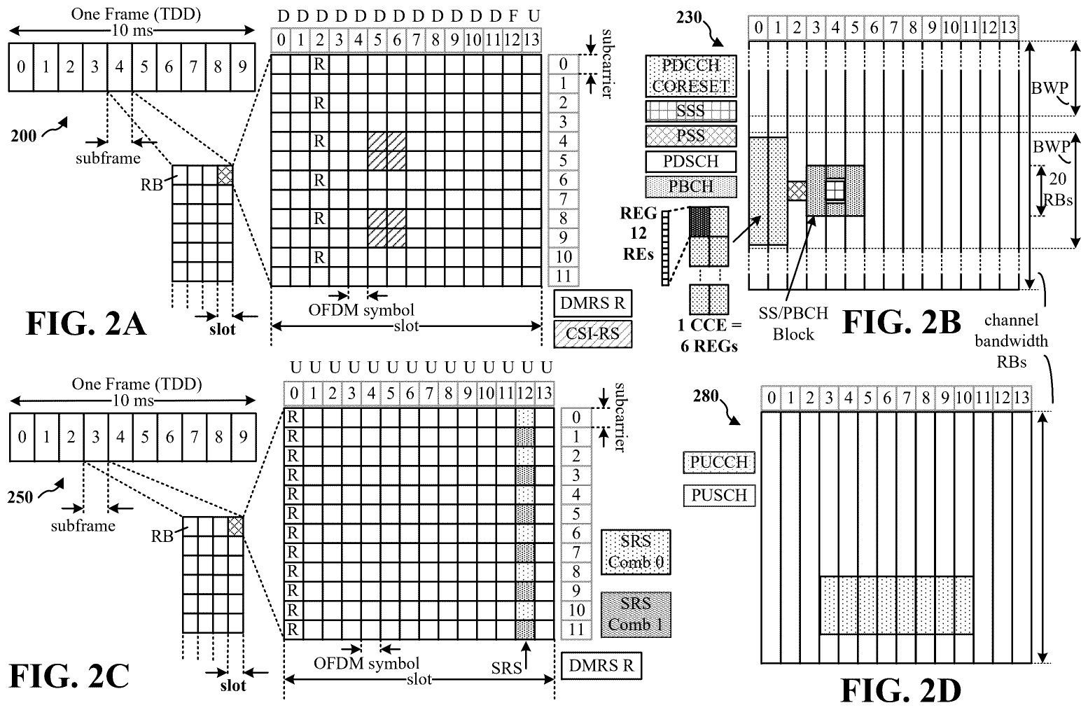

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

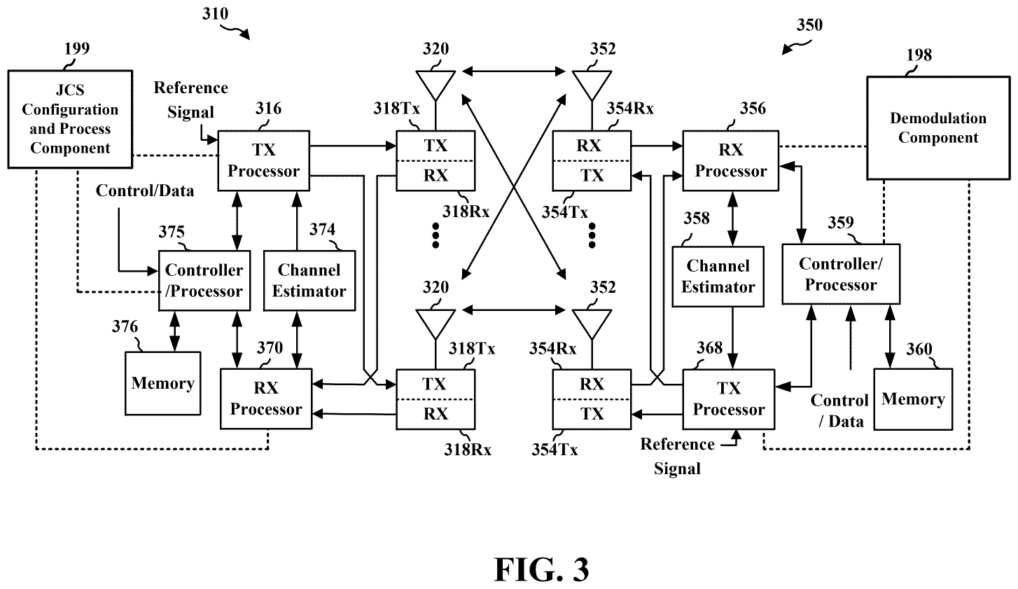

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the demodulation component 198 of FIG. 1.

At least one of the TX processor 316, the RX processor 370, and the controller/processor 375 may be configured to perform aspects in connection with the JCS configuration and process component 199 of FIG. 1.

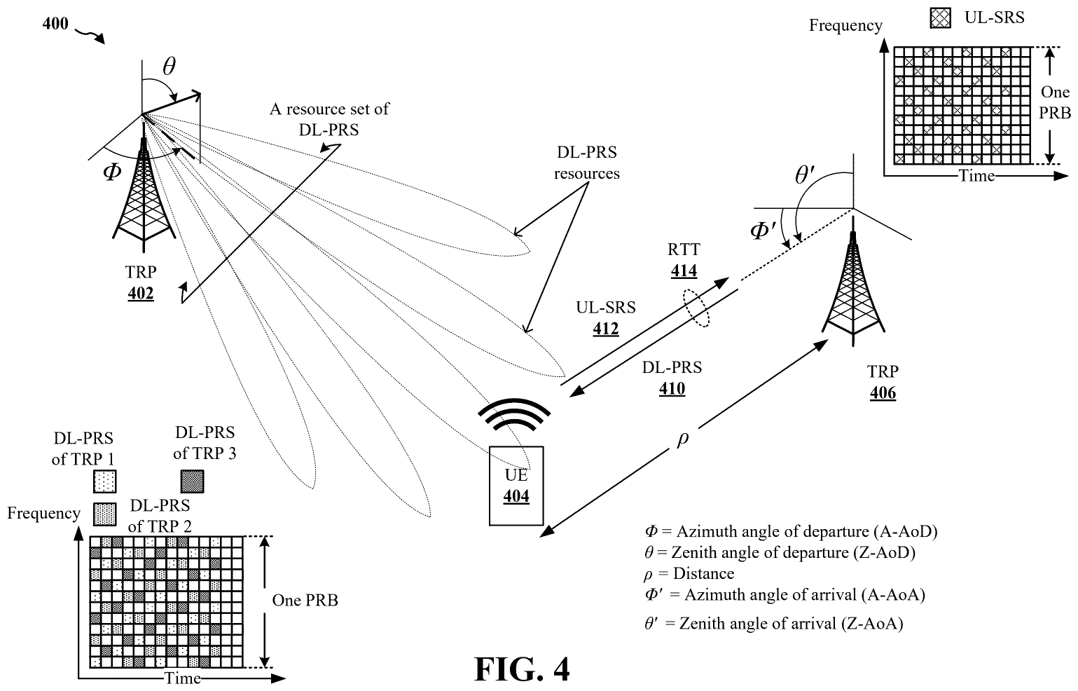

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}-T_{PRS_TX}∥−|T_{SRS_TX}-T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and/or DL-PRS-RSRP of the received signals) using assistance data received from the positioning server, and the TRPs 402, 406 measure the gNB Rx-Tx time difference measurements (and/or UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL-PRS-RSRP) of downlink signals received from multiple TRPs 402, 406 at the UE 404. The UE 404 measures the DL RSTD (and/or DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL-SRS-RSRP) at multiple TRPs 402, 406 of uplink signals transmitted from UE 404. The TRPs 402, 406 measure the UL-RTOA (and/or UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

In addition to network-based UE positioning technologies, a wireless device (e.g., a base station, a component of the base station, a UE, etc.) may also be configured to include radar capabilities, which may be referred to as “sensing,” “radio frequency (RF) sensing” and/or “cellular-based RF sensing.” For example, a wireless device may transmit radar reference signals (RRSs) and measure the RRSs reflected from one or more objects. Based at least in part on the measurement, the wireless device may determine or estimate a distance between the wireless device and the one or more objects. In another example, a first wireless device may also receive RRSs transmitted from a second wireless device, where the first wireless device may determine or estimate a distance between the first wireless device and the second wireless device based at least in part on the received RRS. As such, in some examples, RF sensing techniques may be used for UE positioning and/or for assisting UE positioning. For purposes of the present disclosure, a device that is capable of performing RF sensing (e.g., transmitting and/or receiving RRS for detecting an object or for estimating the distance between the device and the object) may be referred to as an “RF sensing node.” For example, an RF sensing node may be a UE, a base station, a component of the base station, a TRP, a device capable of transmitting RRS, and/or a device configured to perform radar functions, etc.

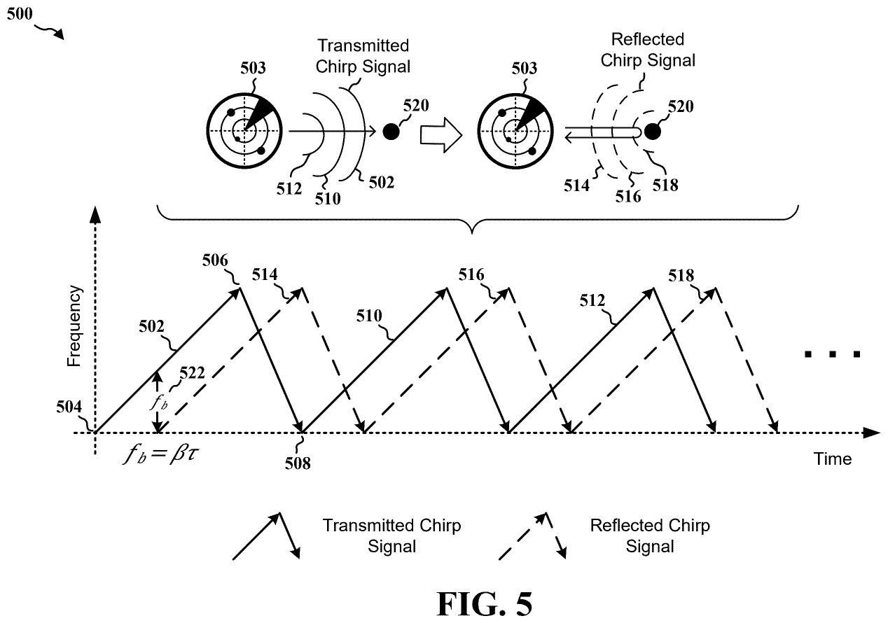

FIG. 5 is a diagram 500 illustrating an example radar signal (e.g., RRS) generated from an RF sensing node in accordance with various aspects of the present disclosure. An RF sensing node 503 may detect an object 520 (e.g., the location, the distance, and/or the speed of the object 520 with respect to the RF sensing node 503) by transmitting RRS towards the object 520 and receiving the RRS reflected (e.g., bounce off) from the object 520. In some examples, the object 520 may be a radar receiver or have a capability to receive and process RRS.

In one example, the RRS may be a chirp signal that includes a frequency that varies linearly (e.g., has a frequency sweeping) over a fixed period of time (e.g., over a sweep time) by a modulating signal. For example, as shown by the diagram 500, a transmitted chirp signal 502 may have a starting frequency at 504 of a sinusoid. Then, the frequency may gradually (e.g., linearly) increase on the sinusoid until it reaches an ending (or highest) frequency at 506 of the sinusoid, and then the frequency of the signal may return to the starting frequency as shown at 508 and another chirp signal 510 may be transmitted in the same way. In other words, each chirp signal may include an increase in frequency (e.g., linearly) and a drop in frequency or vice versa (e.g., including a decrease in frequency and then an increase in frequency), such that the RF sensing node 503 may transmit chirp signals sweeping in frequency. In some examples, such chirp signal may also be referred to as a frequency modulated continuous wave (FMCW).

After a chirp signal (e.g., chirp signal 502, 510, 512, etc.) is transmitted by the RF sensing node 503, the transmitted chirp signal may reach the object 520 and reflect back to the RF sensing node 503, such as shown by the reflected chirp signals 514, 516, and 518, which may correspond to the transmitted chirp signals 502, 510, and 512, respectively. As there may be a distance between the RF sensing node 503 and the object 520 and/or it may take time for a transmitted chirp signal to reach the object 520 and reflect back to the RF sensing node 503, a delay may exist between a transmitted chirp signal and its corresponding reflected chirp signal. As the delay may be proportional to a range between the RF sensing node 503 and the object 520 (e.g., the further the target, the larger the delay and vice versa), the RF sensing node 503 may be able to measure or estimate a distance between the RF sensing node 503 and the object 520 based on the delay.

In some examples, the RF sensing node 503 may also measure a difference in frequency between the transmitted chirp signal and the reflected chirp signal, which may also be proportional to the distance between the RF sensing node 503 and the object 520. In other words, as the frequency difference between the reflected chirp signal and the transmitted chirp signal increases with the delay, and the delay is linearly proportional to the range, the distance of the object 520 from the RF sensing node 503 may also be determined based on the difference in frequency. Thus, the reflected chirp signal from the object 520 may be mixed with the transmitted chirp signal and down-converted to produce a beat signal (fb) which may be linearly proportional to the range after demodulation. For example, the RF sensing node 503 may determine a beat signal 522 by mixing the transmitted chirp signal 502 and its corresponding reflected chirp signal 514. While examples in the diagram illustrate using an FMCW waveform for the RRS, other types of radar waveforms may also be used by the RF sensing node 503 for the RRS.

Typically, radar systems send probing signals to uncooperative targets and infer useful information contained in the target echoes, and communication systems enable information to be exchanged between two or more cooperative transceivers. Due to an increased amount of bandwidth (BW) being allocated for cellular communications systems (e.g., 5G and beyond) and an increased amount of applications (e.g., use cases) being introduced with cellular communications systems, joint communication and RF sensing, which may also be referred to as joint communication and sensing (JCS), integrated sensing and communication (ISAC), and/or joint communication-radar (JCR) (collectively as JCS hereafter), may become an important feature for cellular systems. JCS may refer to an integrated system that is capable of simultaneously performing both wireless communication and remote radar sensing, which may provide a cost-efficient deployment for both radar and communication systems. Time, frequency, and/or spatial radio resources may be allocated to support two purposes (communication and sensing) in the integrated system. For example, a wireless device (e.g., a base station, a component of a base station, a UE, a component of a UE, an RF sensing node, etc.) may be configured to transmit communication signals (e.g., PDSCH, PUSCH, PSSCH, etc.) with radar signals (e.g., RRS, FMCW signals, etc.) simultaneously or close in time (e.g., based on TDM, FDM, SDM, etc.). In addition, OFDM waveform (or its variants) may be used as the waveform for the JCS as the OFDM waveform may enable in-band multiplexing with other cellular reference signals and physical channels. As such, the radar signals may be multiplexed with communication signals based on OFDM waveform. For purposes of the present disclosure, a wireless device that performs an RF sensing based on OFDM waveform(s) or transmits RRS based on OFDM waveform(s) may be referred to as an “OFDM radar.”

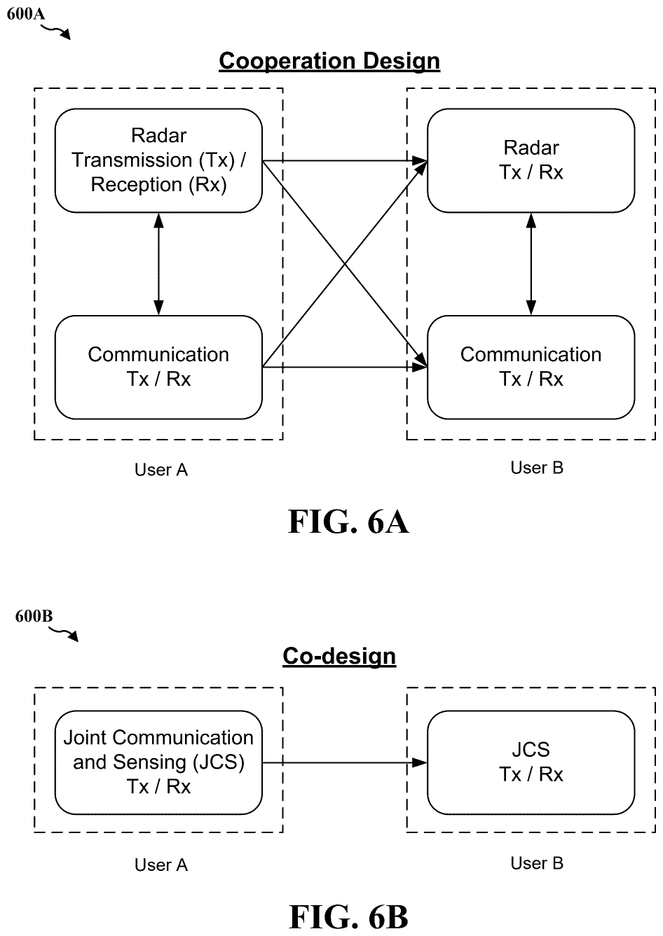

In some implementations, JCS systems may be categorized as co-located and cooperative radar and communication systems and co-design of communication and radar systems. FIG. 6A is a diagram 600A illustrating an example co-located and cooperative radar and communication system in accordance with various aspects of the present disclosure. For this type of JCS system, some knowledge (e.g., transmission information/configuration) is shared between the communication aspect and radar aspect of the system to improve the system's performance, without much altering the core operation of the radar and communication system. For example, as shown by the diagram 600A, each of the devices used by a first user (user A) and a second user (user B) may include a radar transmission (Tx)/reception (Rx) component that is capable of transmitting/receiving radar reference signals (RRSs) and a communication Tx/Rx component that is capable of transmitting/receiving communication signals. The radar Tx/Rx component and the communication Tx/Rx component may communicate with each to coordinate the transmission of radar signals and communication signals to other devices and/or the reception of radar signals and communication signals from other devices.

FIG. 6B is a diagram 600B illustrating an example co-design of communication and radar system in accordance with various aspects of the present disclosure. For this type of JCS system, as shown by the diagram 600B, a common transmitter or receiver is used for both communication and radar functionalities. This type of system may specify certain amount of modifications in the transmitting waveform generation or the receiver processing of both or either of the radar and communication systems. This type of JCS system design may provide an improved hardware and spectrum reuse. Communication-centric JCS that exploits a single communication transmission hardware may be favored by some network implementation because it may support both high-data rate communication and high-resolution sensing. For example, as described above, OFDM-based waveform may be used by the radar system for sensing purpose while remaining compatible with OFDM-based communication system.

Coherent multi-input multi-output (MIMO) radar, an extension of the phased array antenna that may be used by radar systems, may be utilized to achieve accurate angle of arrival (AoA) estimation resolution by increasing the effective antenna (array) aperture at the radar receiver. For coherent MIMO radar, transmission (Tx) and reception (Rx) antennas may be configured to be collocated to perform MIMO radar sensing. For example, the radar transmitter of a coherent MIMO radar system may transmit orthogonal waveforms on different Tx antennas, and at Rx, the contribution of each Tx antenna may be extracted by exploiting waveform orthogonality.

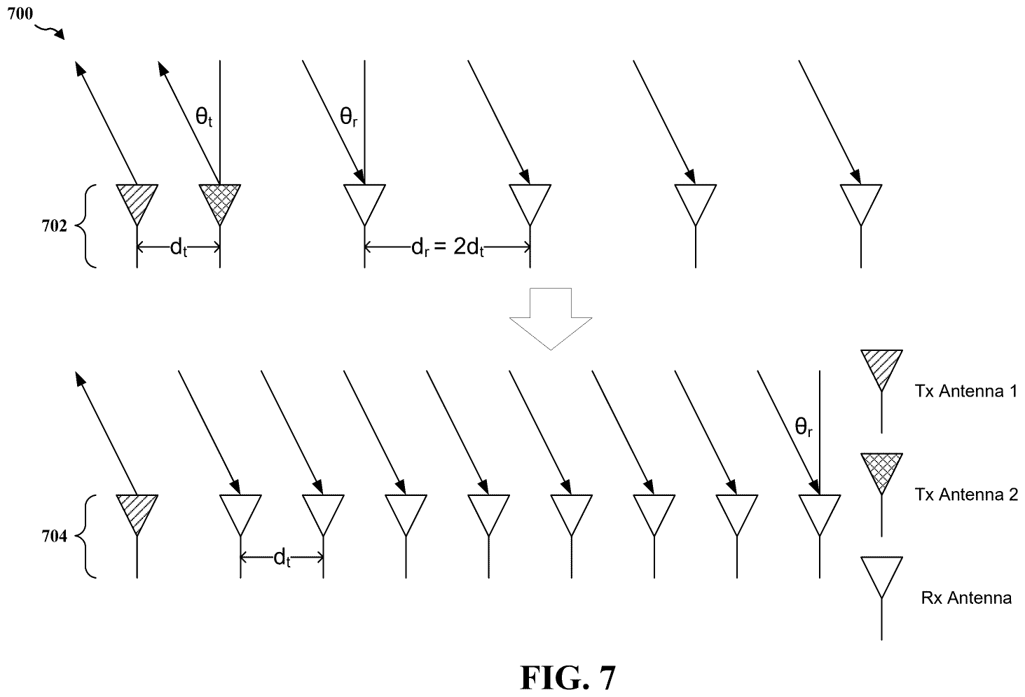

FIG. 7 is a diagram 700 illustrating an example of MIMO radar configurations in accordance with various aspects of the present disclosure. When a MIMO radar is configured with two (2) Tx antennas and Mᵣ Rx antennas, the synthetic virtual array may be equivalent to uniform linear arrays (ULAs) with 2*Mᵣ elements and a spacing of dₜ when θₜ=θᵣ. For example, as shown at 702, when there are two (2) Tx antennas and four (4) Rx antennas for a MIMO radar, the AoA estimation performance for this MIMO radar may be the same as a MIMO radar with one (1) Tx antennas and eight (8) Rx antennas (e.g., 2×4=1×8) as shown at 704.

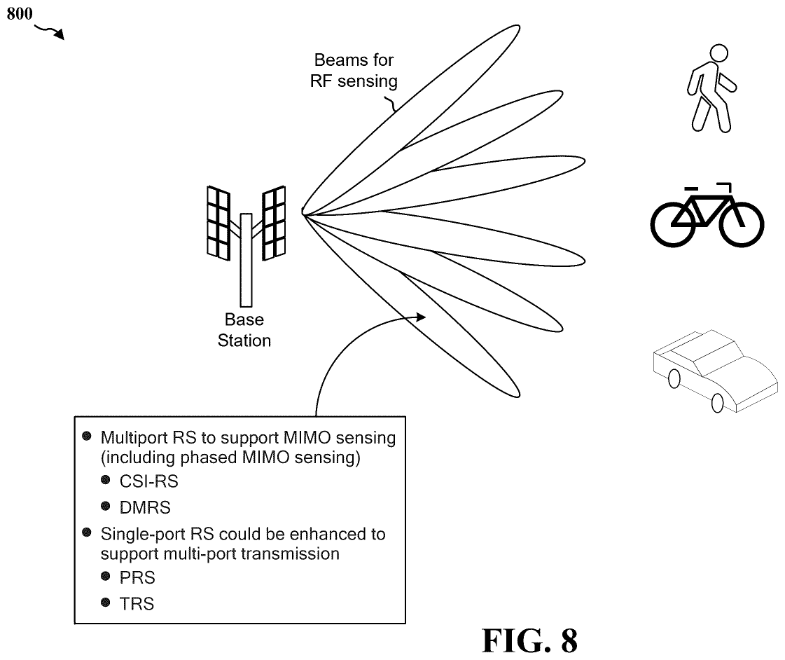

FIG. 8 is a diagram 800 illustrating an example of joint MIMO sensing and communications in accordance with various aspects of the present disclosure. In some examples, multiport reference signal (RS), such as channel state information RS (CSI-RS) and demodulation RS (DMRS) may be used for supporting MIMO sensing. In other examples, single-port RS, such as PRS and tracking RS (TRS), may be enhanced to support multi-port transmission for MIMO sensing. However, using these multiple port and single port RSs may increase signaling overhead as the resource density of the RSs may be specified to increase for supporting RF sensing.

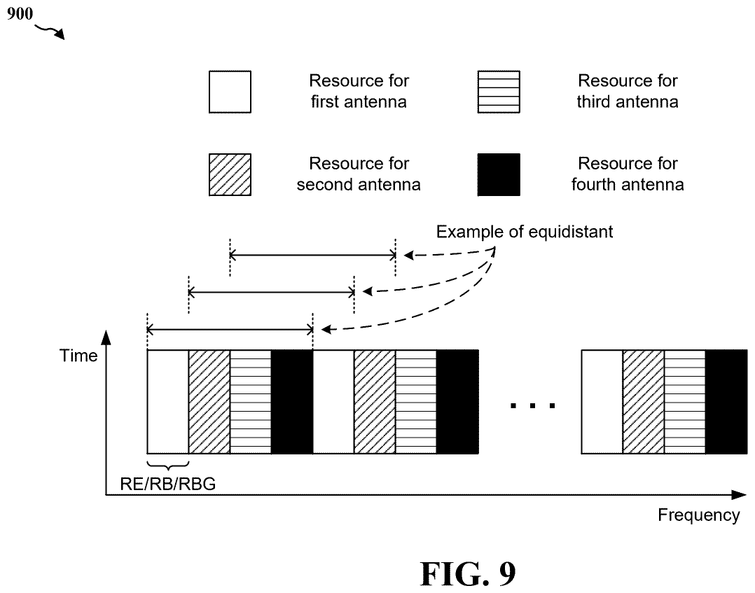

FIG. 9 is a diagram 900 illustrating an example of equidistant resource element (RE)/resource block (RB)/resource block group (RBG) level interleaving in accordance with various aspects of the present disclosure. In some scenarios, a JCS system may use data payload (e.g., PDSCH) for joint MIMO sensing and communications. For example, as described in connection with FIGS. 5, 6A, and 6B, OFDM-based waveform may be used by the radar system for sensing purpose while remaining compatible with OFDM-based communication system. In one example, as shown by the diagram 900, resource allocation for OFDM-based MIMO sensing (e.g., frequency division multiplex (FDM) based waveform orthogonality) may be based on equidistant RE/RB/RBG level interleaving, where frequency resources allocated for each Tx antenna are interleaved with equal distance based on RE/RB/RBG. Under such resource allocation configuration, the unambiguously measurable range (UMR) for the RF sensing may be reduced due to increased spacing between subcarriers for each transmission. UMR may refer to a maximum range at which a target may be located by a radar so as to guarantee that the reflected signal/pulse from that target corresponds to the most recent transmitted pulse.

In another example, resource allocation for OFDM-based MIMO sensing may be based on non-equidistant RE/RB/RBG level interleaving, where frequency resources allocated for each Tx antenna may not have equal distance. Such resource allocation configuration may overcome the drawback of equidistant interleaving in terms of reduced UMR. However, such configuration may also specify higher Rx processing capability.

As JCS is likely to be an important feature for future cellular systems, one goal for implementing JCS is using a unified waveform for both communication and RF sensing, such that there may be a higher spectrum efficiency since the spectrum may be fully reused and/or unified hardware (HW) components may be configured/used for both communication and RF sensing.

Aspects presented herein may improve the performance of a JCS system by providing various resource mapping for the sensing and communication of the JCS system. Aspects presented herein may enable a base station to use PDSCH for MIMO sensing with FDM based waveform orthogonality, and may also enable a UE to support DMRS channel estimation when PDSCH is used for MIMO sensing with FDM based waveform orthogonality (e.g., linking DMRS port to PDSCH based on the resource mapping to enable channel estimation for decoding).

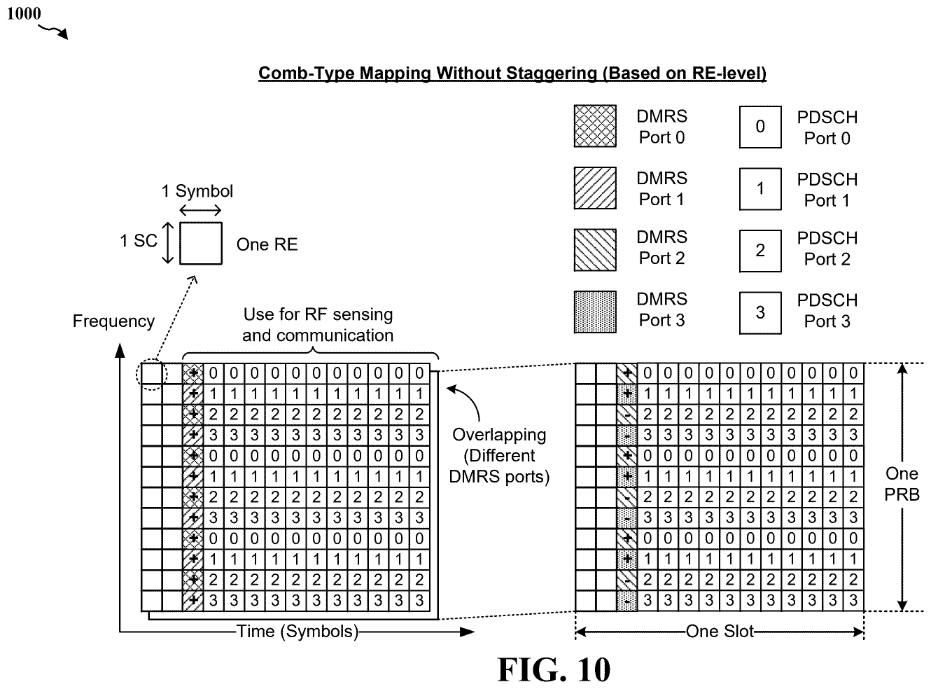

FIG. 10 is a diagram 1000 illustrating an example comb-type resource mapping without staggering (or without a staggering pattern) in accordance with various aspects of the present disclosure. A base station may perform JCS based on PDSCH, where the base station may use the PDSCH for RF sensing and for transmitting data to a UE simultaneously. In one aspect, the base station may transmit the PDSCH to the UE based on a comb-type resource mapping without staggering, where the number of DMRS ports (P) and DMRS resource mapping may be pre-designed and applied for both sensing and communication purposes (e.g., NR DMRS design). Thus, when a UE is allocated/configured with MIMO JCS resources, PDSCH RE mapping per DMRS port described herein may be applied. For example, as shown by the diagram 1000, PDSCH symbols for port-x may be mapped to subcarriers (SCs) satisfying (n_{sc} mod P)=x, where n_{sc} is the subcarrier index and P is the number of DMRS/PDSCH ports. Thus, DMRS port-x may be used by the UE for demodulation of port-x PDSCH based on this resource mapping. In other words, the UE may demodulate each PDSCH of a port based on the DMRS received through that port. For example, if the base station is transmitting PDSCH/DMRS to the UE using a total of four ports (e.g., P=4), such as via four antennas, subcarrier index (n_{sc}) 0, 1, 2, 3, 4, 5, 6, 7, 8, 9, 10, and 11 may map to PDSCH ports 0, 1, 2, 3, 0, 1, 2, 3, 0, 1, 2, and 3, respectively. In some examples, additional frequency-domain interleaving may also be applied (e.g., using different interleaving per symbol) to achieve interference randomization and/or to provide non-equidistance RE mapping to avoid aliasing problems.

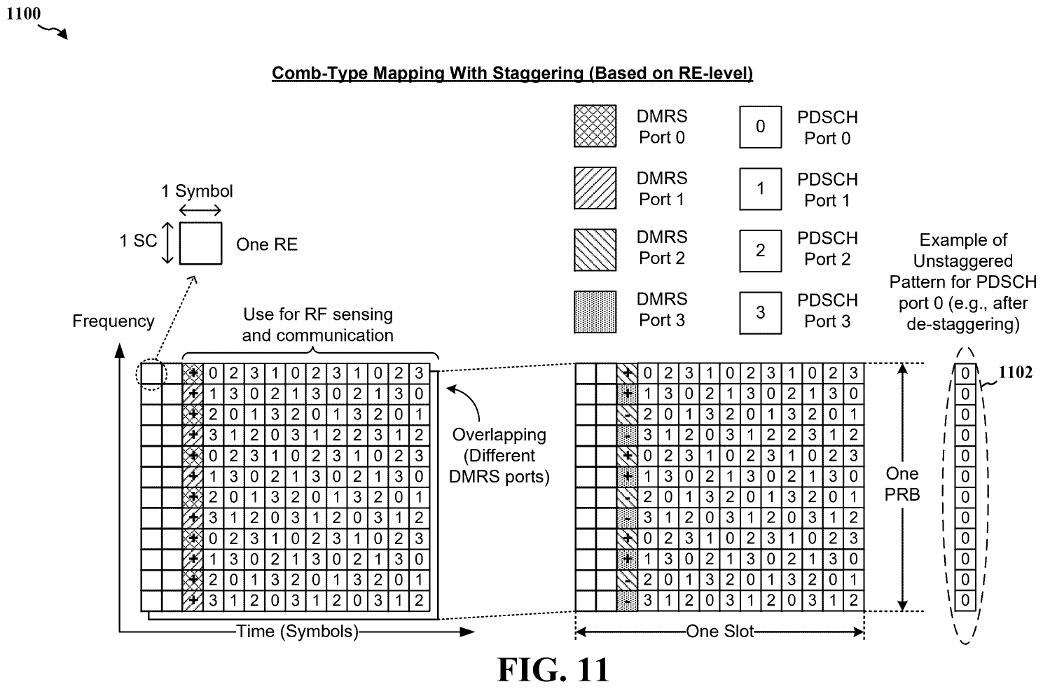

FIG. 11 is a diagram 1100 illustrating an example comb-type resource mapping with staggering (or with a staggering pattern) in accordance with various aspects of the present disclosure. In another aspect of the present disclosure, the base station may transmit the PDSCH to the UE based on a comb-type resource mapping with staggering. As the per-port PDSCH mapping described in connection with FIG. 10 (e.g., applying a fixed comb structure across symbols in a slot) may cause an aliasing problem for range detection, to provide full frequency-domain sensing information, a staggering pattern or structure may be applied to the PDSCH symbols on top of the comb structure.

The PDSCH port mapping pattern illustrated by the diagram 1100 may be referred to as a “staggered pattern” or a “staggering pattern,” where the resource elements on which the PDSCHs are transmitted via each port may be staggered in the frequency domain of a given bandwidth such that these resource elements are not adjacent to each other in two consecutive resource elements on the given bandwidth. In addition, while the resource elements on which the PDSCHs are transmitted may be staggered over multiple symbols, the resource elements may occupy the whole bandwidth if they are de-staggered. For example, the diagram 1100 illustrates an example resource mapping based on a comb-4 with 11 symbols pattern, where there is one resource element per every four subcarriers in the frequency domain for each PDSCH port among the 11 symbols. In addition, a set of frequency offsets may be applied to the PDSCH resource elements in each of the occupying symbols, such that the PDSCH resource elements may not be adjacent to each other on the time domain. As shown at 1102, while the PDSCH resource elements may be staggered in a given bandwidth (and also on a given time domain), after a UE receives these PDSCH resource elements, the UE may be able to receive the full bandwidth of the PDSCH, which may be referred to as de-staggering a staggered pattern or turning a staggered pattern to an unstaggered pattern.

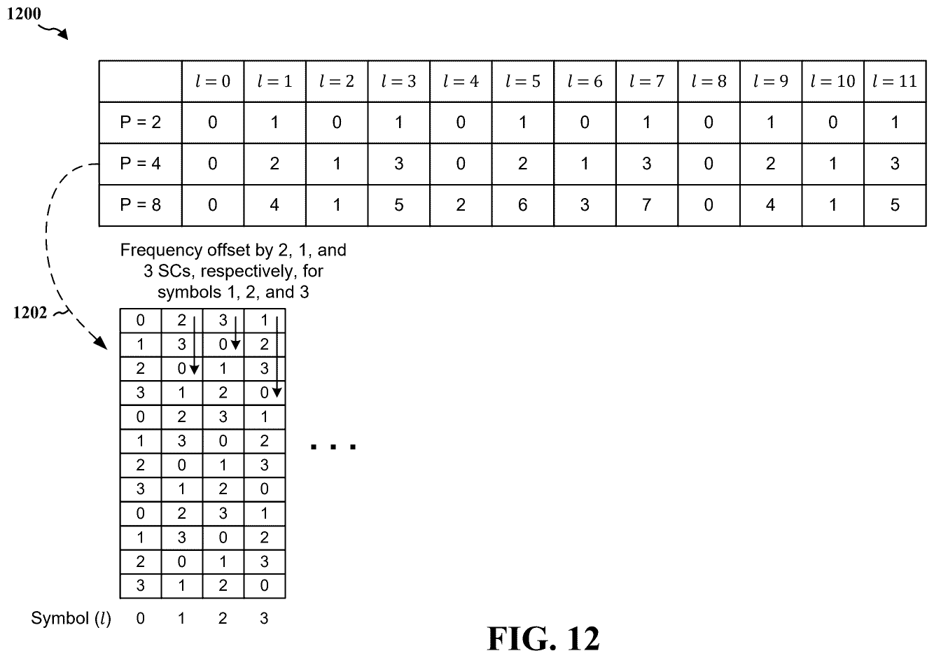

In one example, the PDSCH symbols for port-x may be mapped to subcarriers satisfying ((n_{sc}+n_{offset}(l)) mod P)=x, where n_{sc} is the subcarrier index and n_{offset}(l) may be defined as a function of symbol number (l) and number of ports (P). FIG. 12 is a diagram 1200 illustrating example values for frequency offset (e.g., n_{offset}(l)) for different symbol number (l) and/or different number of ports (P) in accordance with various aspects of the present disclosure. For example, when there are a total of four ports (e.g., P=4), the frequency offset for symbol numbers 0, 1, 2, 3, 4, 5, 6, 7, 8, 9, 10, and 11 may correspond to 0, 2, 1, 3, 0, 2, 1, 3, 0, 2, 1, and 3, respectively, such as shown at 1202.

In another aspect of the present disclosure, to reduce or overcome the receiver (Rx) processing complexity of RE-level comb-type mapping described in connection with FIGS. 10 and 11, RE group (REG)-level PDSCH mapping may be configured instead of RE level PDSCH mapping, where REs for each PDSCH port are mapped in a group. For example, PDSCH symbols for port-x may be mapped to subcarriers satisfying (n_{sc} mod GP)∈{Gx, Gx+1, . . . G(x+1)−1}, where G is REG size which may be configured by a base station or a specified value depending on the number of ports (P). For example, (G=6 for P=2, G=4 for P=3, G=3 for P=4, G=2 for P=5 or 6).

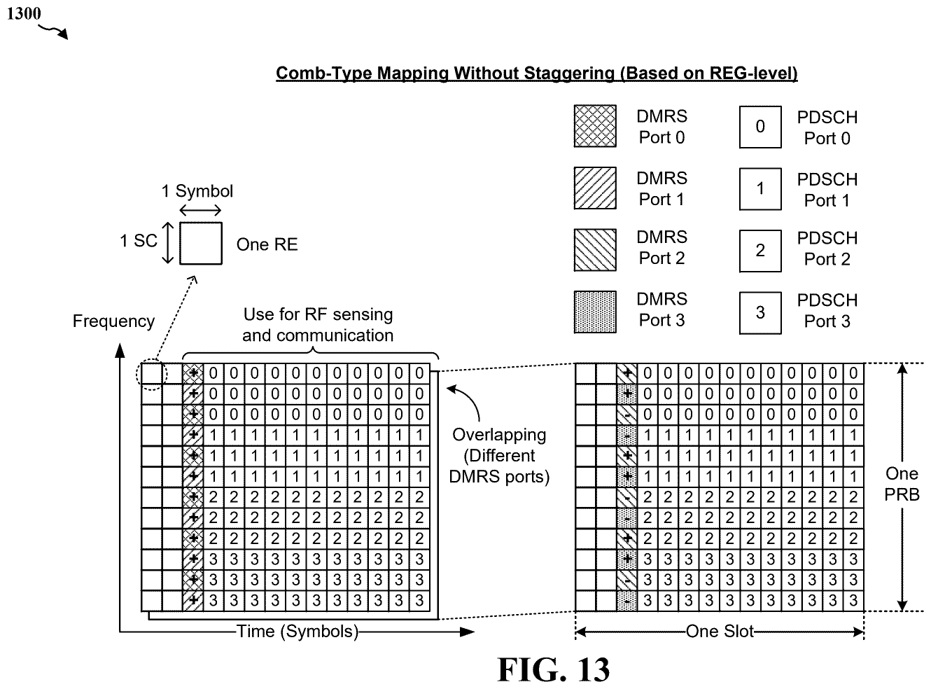

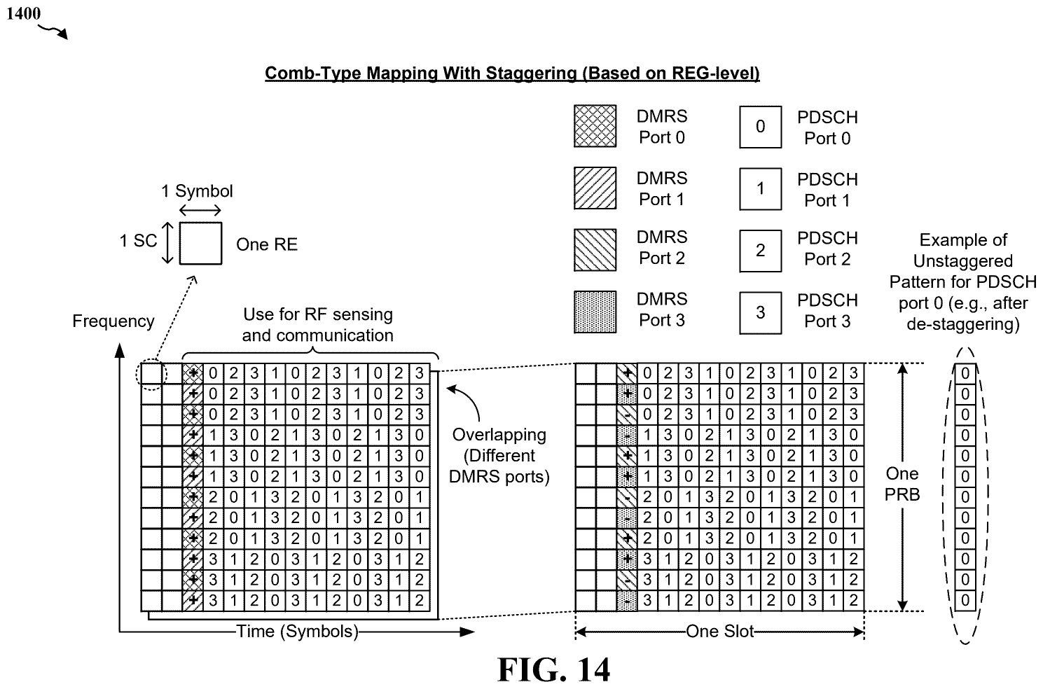

FIG. 13 is a diagram 1300 illustrating an example comb-type resource mapping without staggering (or without a staggering pattern) in accordance with various aspects of the present disclosure. The base station may transmit the PDSCH to the UE based on a comb-type resource mapping without staggering based on REG. For example, for each symbol, first three SCs may be allocated for a first PDSCH port (e.g., PDSCH port 0), next three SCs may be allocated for a second PDSCH port (e.g., PDSCH port 1), and next three SCs may be allocated for a third PDSCH port (e.g., PDSCH port 2), and the last three SCs may be allocated for a fourth PDSCH port (e.g., PDSCH port 3), etc. Similarly, in some examples, additional frequency-domain interleaving may also be applied (e.g., using different interleaving per symbol) to achieve interference randomization and/or to provide non-equidistance RE mapping to avoid aliasing problems. In addition, as shown by a diagram 1400 of FIG. 14, staggering pattern/structure may also be applied to REG-level port mapping.

In another aspect of the present disclosure, the mapping for PDSCH/DMRS ports may be based on resource block (RB) or resource block group (RBG) level, where each RB/RBG is used for each PDSCH/DMRS port, and the UE may decode the corresponding PDSCH based on the DMRS received via the RB/RBG.

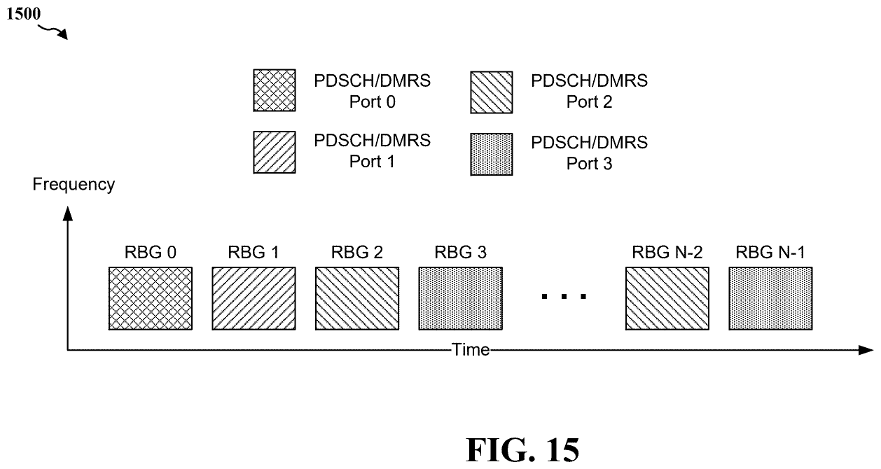

FIG. 15 is a diagram 1500 illustrating an example of RB/RBG-level port mapping in accordance with various aspects of the present disclosure. In one example, RB/RBG-level port mapping may be supported in a UE-transparent manner, where different RBs/RBGs may apply different precoding (or antenna port mapping) without UE awareness. For example, as shown by the diagram 1500, a first RBG may be assigned to a first PDSCH/DMRS port, a second RBG may be assigned to a second PDSCH/DMRS port, a third RBG may be assigned to a third PDSCH/DMRS port, and a fourth RBG may be assigned to a fourth PDSCH/DMRS port, etc. Similarly, different RBs/RBGs may be configured to different PDSCH/DMRS ports based on interleaving, such that no two consecutive RBs/RBGs are transmitted via the same PDSCH/DMRS port.

In another aspect of the present disclosure, to efficiently support MIMO radar sensing, a different virtual resource block (VRB)-to-PRB mapping may be used when sensing is performed in certain slot(s). For example, for communication without sensing, a VRB-to-PRB mapping for PDSCH may be based on mapping the closest VRBGs to the furthest PRBGs. However, when a specific slot is used for sensing, a different VRB-to-PRB mapping that is capable of distributing contiguous VRBGs throughout the overall BWP may be used instead, such as based on the mapping described in connection with FIG. 15. In addition, a base station may configure a UE with slots that are to be applied with the different VRB-to-PRB mapping via radio resource control (RRC) or dynamically indicated to the UE via downlink control information (DCI) in physical downlink control channel (PDCCH).

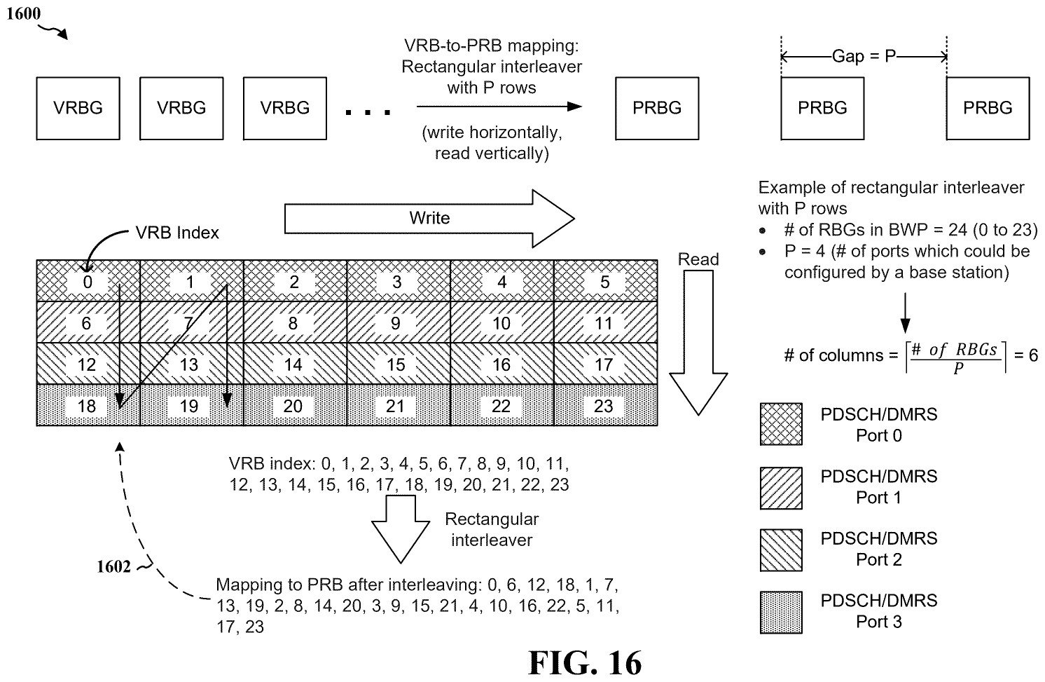

FIG. 16 is a diagram 1600 illustrating an example VRB-to-PRB mapping based on rectangular interleaver with P rows in accordance with various aspects of the present disclosure. In one example, if there are 24 RBGs in a bandwidth part (e.g., RBGs #0 to #23) and there is a total of four ports which may be configured by a base station for transmitting PDSCH/DMRS (e.g., P=4), then a rectangular table with four rows and six columns may be defined based on the number of

$$columns = ⌈ \frac{\# of RBGs}{P} ⌉ = 24 / 4 = 6.$$

Then the base station may map the VRB index to PRB based on write horizontally read vertically architecture, such as shown at 1602. For example, VRB index 0, 1, 2, 3, 4, 5, 6, 7, 8, 9, 10, 11, 12, 13, 14, 15, 16, 17, 18, 19, 20, 21, 22, and 23 may be mapped to PRBs #0, 6, 12, 18, 1, 7, 13, 19, 2, 8, 14, 20, 3, 9, 15, 21, 4, 10, 16, 22, 5, 11, 17, and 23, respectively, based on the rectangular interleaver, such that no two consecutive PRBs are transmitted via the same PDSCH/DMRS port.

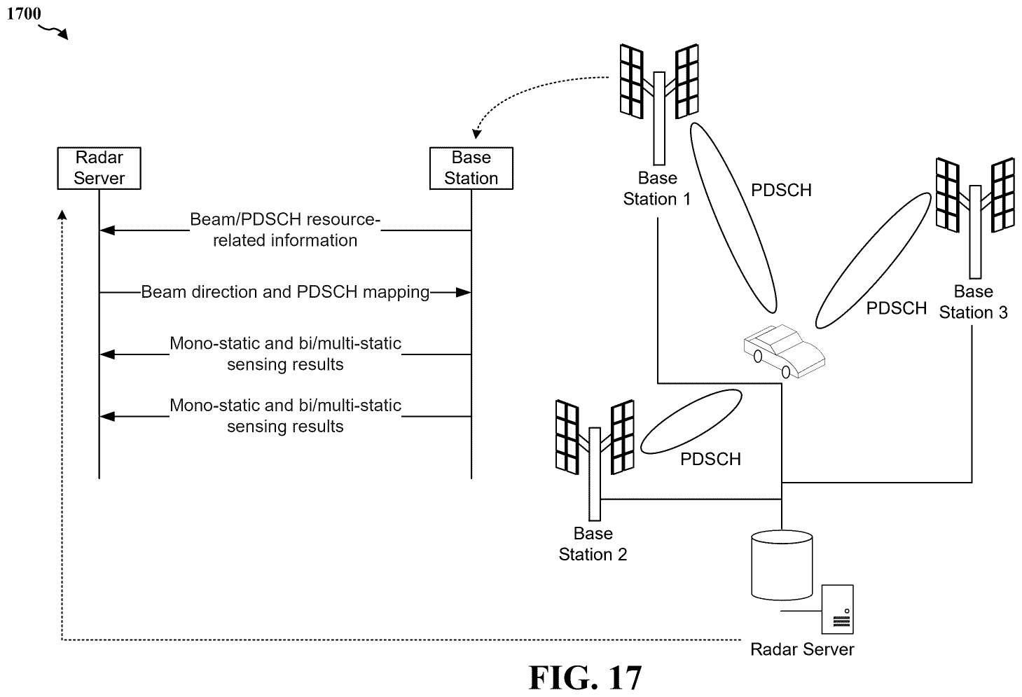

FIG. 17 is a diagram 1700 illustrating an example system architecture for performing RF sensing via multiple base stations in accordance with various aspects of the present disclosure. In one example, multiple base stations, such as a first base station, a second base station, and a third base station, may be connected to a radar server and cooperated to generate sensing information of a certain area. Each cooperating base station may transmit radar probing signals and derives sensing information according to timing, resource, and/or beamforming coordination of the radar server. In one aspect of the present disclosure, the radar server may request a specific port to PDSCH RE mapping (e.g., described in connection with FIGS. 10 to 16) to each base station. In response, each base station may determine the final mapping to be used based on the radar server's request. For example, each of the multiple base stations may transmit its beam/PDSCH resource-related information to the radar server. Based on the beam/PDSCH resource-related information received from the multiple base stations, the radar server may coordinate the multiple base stations to perform sensing for an area or toward a target. In addition, the radar server may also request the multiple base stations to apply a specific port to PDSCH RE mapping as described in connection with FIGS. 10 to 16. In response, the multiple base stations may apply the port to PDSCH RE mapping requested by the radar server and perform the joint communication and sensing (or just the sensing), and the multiple base stations may transmit their sensing result back to the radar server.

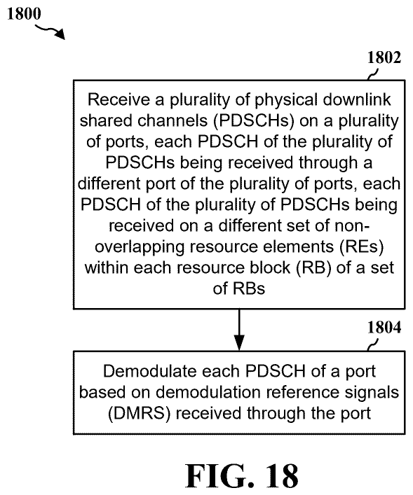

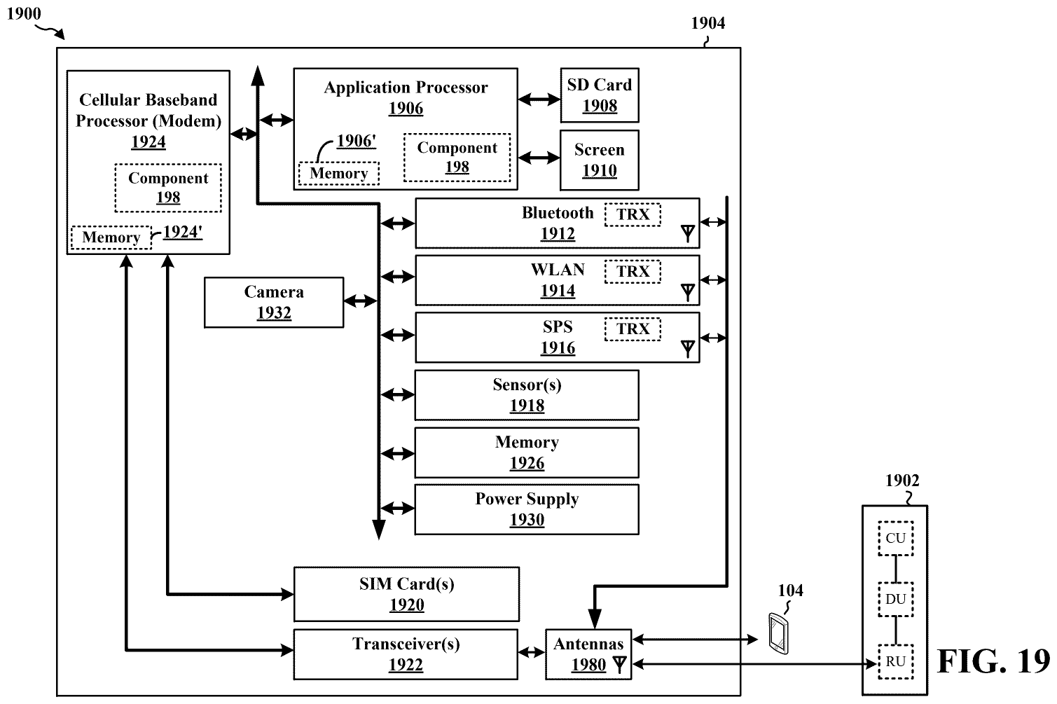

FIG. 18 is a flowchart 1800 of a method of wireless communication/RF sensing. The method may be performed by a UE or a component of a UE (e.g., the UE 104, 404; the apparatus 1904). At 1802, the UE may receive a plurality of PDSCHs on a plurality of ports, each PDSCH of the plurality of PDSCHs being received through a different port of the plurality of ports, each PDSCH of the plurality of PDSCHs being received on a different set of non-overlapping REs within each RB of a set of RBs, such as described in connection with FIGS. 10 to 14. For example, as shown by FIGS. 10 and 11, a UE may receive a plurality of PDSCHs on four ports, each PDSCH of the plurality of PDSCHs being received through a different port of the plurality of ports, each PDSCH of the plurality of PDSCHs being received on a different set of non-overlapping REs within each RB of a set of RBs (e.g., based on non-staggering or staggering pattern). The reception of the plurality of PDSCHs may be performed by, e.g., the demodulation component 198 and/or the transceiver 1922 of the apparatus 1904 in FIG. 19.

At 1804, the UE may demodulate each PDSCH of a port based on DMRS received through the port, such as described in connection with FIGS. 10 to 14. For example, as described in connection with FIGS. 10 and 11, after the UE receives multiple PDSCH from four ports, the UE may demodulate each PDSCH of a port based on DMRS received through the port. The demodulation of the PDSCH may be performed by, e.g., the demodulation component 198 of the apparatus 1904 in FIG. 19.

In one example, each PDSCH of the plurality of PDSCHs may be received on a different set of non-overlapping subcarriers within each RB of the set of RBs. In such an example, the plurality of ports may include p ports, each set of non-overlapping subcarriers may include n subcarriers, and the PDSCH for a particular port has a subcarrier gap of n(p−1) subcarriers. In such an example, n=1 and each PDSCH of the plurality of PDSCHs may be received on a different subcarrier within each RB of the set of RBs.

In another example, each PDSCH of the plurality of PDSCHs may be received on a different set of staggered non-overlapping REs within each RB of the set of RBs. In such an example, the different set of staggered non-overlapping REs may include subsets of REs that are non-adjacent in time and frequency to each other. In such an example, the different set of staggered non-overlapping REs may include REs that are non-adjacent in time and frequency to each other.

FIG. 19 is a diagram 1900 illustrating an example of a hardware implementation for an apparatus 1904. the apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, additional memory modules 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. In some examples, the cellular baseband processor 1924/application processor 1906 may be a component of the UE 350 and may include the memory 360 and/or at least one of the TX processor 368, the RX processor 356, and the controller/processor 359. In other examples, the cellular baseband processor 1924/application processor 1906 may be a component of a base station and may include the TX processor 316, the RX processor 370, and the controller/processor 375. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the demodulation component 198 is configured to receive a plurality of PDSCHs on a plurality of ports, each PDSCH of the plurality of PDSCHs being received through a different port of the plurality of ports, each PDSCH of the plurality of PDSCHs being received on a different set of non-overlapping REs within each RB of a set of RBs; and demodulate each PDSCH of a port based on DMRS received through the port. The demodulation component 198 may be within the cellular baseband processor 1924, the application processor 1906, or both the cellular baseband processor 1924 and the application processor 1906. The demodulation component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for receiving a plurality of PDSCHs on a plurality of ports, each PDSCH of the plurality of PDSCHs being received through a different port of the plurality of ports, each PDSCH of the plurality of PDSCHs being received on a different set of non-overlapping REs within each RB of a set of RBs; and means for demodulating each PDSCH of a port based on DMRS received through the port.

In another configuration, each PDSCH of the plurality of PDSCHs is received on a different set of non-overlapping subcarriers within each RB of the set of RBs. In such a configuration, the plurality of ports comprises p ports, each set of non-overlapping subcarriers comprises n subcarriers, and the PDSCH for a particular port has a subcarrier gap of n(p−1) subcarriers. In such a configuration, n=1 and each PDSCH of the plurality of PDSCHs is received on a different subcarrier within each RB of the set of RBs.

In another configuration, each PDSCH of the plurality of PDSCHs is received on a different set of staggered non-overlapping resource elements (REs) within each RB of the set of RBs. In such a configuration, the different set of staggered non-overlapping REs comprises subsets of REs that are non-adjacent in time and frequency to each other. In another configuration, the different set of staggered non-overlapping REs comprises REs that are non-adjacent in time and frequency to each other.

The means may be the demodulation component 198 of the apparatus 1904 or configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

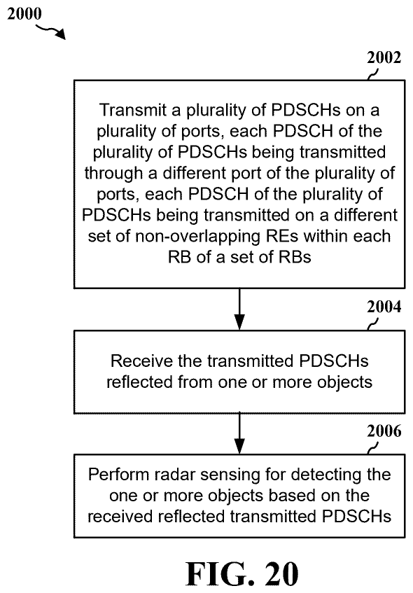

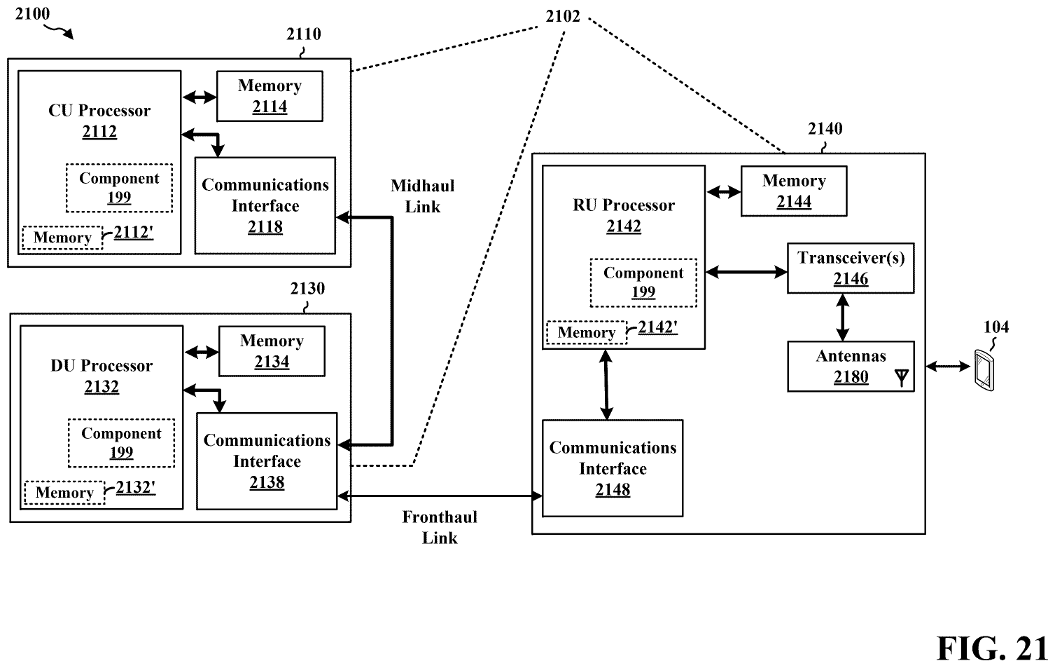

FIG. 20 is a flowchart 2000 of a method of wireless communication/RF sensing. The method may be performed by a base station or a component of a base station (e.g., the base station 102; the network entity 2102). At 2002, the base station may transmit a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs, such as described in connection with FIGS. 10 to 14. For example, as shown by FIGS. 10 and 11, a base station may transmit a plurality of PDSCHs on four ports, each PDSCH of the plurality of PDSCHs being transmitted through a different port of the plurality of ports, each PDSCH of the plurality of PDSCHs being transmitted on a different set of non-overlapping REs within each RB of a set of RBs (e.g., based on non-staggering or staggering pattern). The transmission of the plurality of PDSCHs may be performed by, e.g., the JCS configuration and process component 199 and/or the transceiver 2146 of the network entity 2102 in FIG. 21.

At 2004, the base station may receive the transmitted PDSCHs reflected from one or more objects, such as described in connection with FIGS. 10 to 14 and 17. For example, as the PDSCHs may be used for JCS, the base station may receive PDSCH reflected from one or more objects. The reception of the transmitted PDSCHs reflected from one or more objects may be performed by, e.g., the JCS configuration and process component 199 and/or the transceiver 2146 of the network entity 2102 in FIG. 21.

At 2006, the base station may perform radar sensing for detecting the one or more objects based on the received reflected transmitted PDSCHs, such as described in connection with FIGS. 10 to 14 and 17. For example, as shown by FIG. 15, the first base station, the second base station, and the third base station may perform radar sensing for detecting the one or more objects based on the received reflected transmitted PDSCHs. The radar sensing may be performed by, e.g., the JCS configuration and process component 199 and/or the transceiver 2146 of the network entity 2102 in FIG. 21.

In one example, each PDSCH of the plurality of PDSCHs may be transmitted on a different set of non-overlapping subcarriers within each RB of the set of RBs. In such an example, the plurality of ports may include p ports, each set of non-overlapping subcarriers may include n subcarriers, and the PDSCH for a particular port has a subcarrier gap of n(p−1) subcarriers. In such an example, n=1 and each PDSCH of the plurality of PDSCHs may be transmitted on a different subcarrier within each RB of the set of RBs.

In another example, each PDSCH of the plurality of PDSCHs may be transmitted on a different set of staggered non-overlapping REs within each RB of the set of RBs. In such an example, the different set of staggered non-overlapping REs may include subsets of REs that are non-adjacent in time and frequency to each other. In such an example, the different set of staggered non-overlapping REs may include REs that are non-adjacent in time and frequency to each other.

In another example, the base station may receive from a radar server beam direction information, where the plurality of PDSCHs are transmitted in beam directions based on the received beam direction information.

In another example, the base station may receive from a radar server PDSCH mapping information, where the plurality of PDSCHs are mapped to REs based on the PDSCH mapping information.

In another example, the base station may transmit, to a radar server, radar sensing results based on the performed radar sensing.

FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include a CU processor 2112. The CU processor 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include a DU processor 2132. The DU processor 2132 may include on-chip memory 2132′. In some aspects, the DU 2130 may further include additional memory modules 2134 and a communications interface 2138. The DU 2130 communicates with the RU 2140 through a fronthaul link. The RU 2140 may include an RU processor 2142. The RU processor 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the JCS configuration and process component 199 is configured to transmit a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs; receive the transmitted PDSCHs reflected from one or more objects; and perform radar sensing for detecting the one or more objects based on the received reflected transmitted PDSCHs. The JCS configuration and process component 199 may be within one or more processors of one or more of the CU 2110, DU 2130, and the RU 2140. The JCS configuration and process component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2102 may include a variety of components configured for various functions. In one configuration, the network entity 2102 includes means for transmitting a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs; means for receiving the transmitted PDSCHs reflected from one or more objects; and means for performing radar sensing for detecting the one or more objects based on the received reflected transmitted PDSCHs.

In another configuration, each PDSCH of the plurality of PDSCHs is transmitted on a different set of non-overlapping subcarriers within each RB of the set of RBs. In such a configuration, the plurality of ports comprises p ports, each set of non-overlapping subcarriers comprises n subcarriers, and the PDSCH for a particular port has a subcarrier gap of n(p−1) subcarriers. In such configuration, n=1 and each PDSCH of the plurality of PDSCHs is transmitted on a different subcarrier within each RB of the set of RBs.

In another configuration, each PDSCH of the plurality of PDSCHs is transmitted on a different set of staggered non-overlapping REs within each RB of the set of RBs. In such a configuration, the different set of staggered non-overlapping REs comprises subsets of REs that are non-adjacent in time and frequency to each other. Alternatively, the different set of staggered non-overlapping REs comprises REs that are non-adjacent in time and frequency to each other.

In another configuration, the network entity 2102 further includes means for receiving from a radar server beam direction information, where the plurality of PDSCHs are transmitted in beam directions based on the received beam direction information.

In another configuration, the network entity 2102 further includes means for receiving from a radar server PDSCH mapping information, where the plurality of PDSCHs are mapped to REs based on the PDSCH mapping information.

In another configuration, the network entity 2102 further includes means for transmitting, to a radar server, radar sensing results based on the performed radar sensing.

The means may be the JCS configuration and process component 199 of the network entity 2102 configured to perform the functions recited by the means. As described supra, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

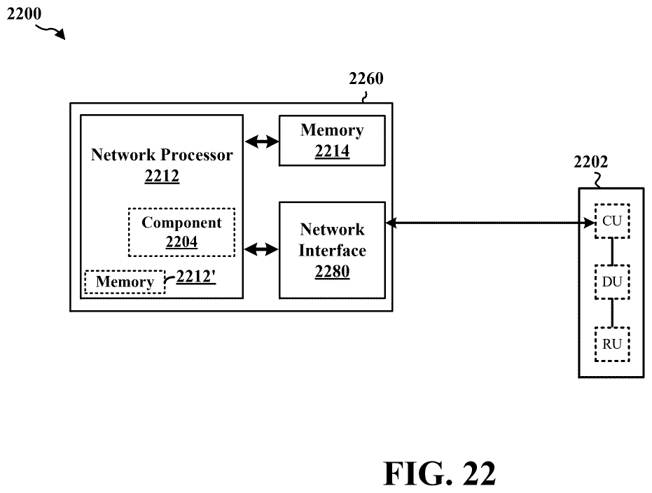

FIG. 22 is a diagram 2200 illustrating an example of a hardware implementation for a network entity 2260. In one example, the network entity 2260 may be within the core network 120. The network entity 2260 may include a network processor 2212. The network processor 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The on-chip memory 2212′ and the additional memory modules 2214 may each be considered a computer-readable medium/memory. Each computer-readable medium/memory may be non-transitory. The processor 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 2204 is configured to transmit a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs; receive the transmitted PDSCHs reflected from one or more objects; and perform radar sensing for detecting the one or more objects based on the received reflected transmitted PDSCHs. The component < > may be within the processor 2212. The component 2204 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2260 may include a variety of components configured for various functions. In one configuration, the network entity 2260 includes means for transmitting a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs; means for receiving the transmitted PDSCHs reflected from one or more objects; means for performing radar sensing for detecting the one or more objects based on the received reflected transmitted PDSCHs; means for receiving from a radar server beam direction information, where the plurality of PDSCHs are transmitted in beam directions based on the received beam direction information; means for receiving from a radar server PDSCH mapping information, where the plurality of PDSCHs are mapped to REs based on the PDSCH mapping information; and means for transmitting, to a radar server, radar sensing results based on the performed radar sensing. The means may be the component 2204 of the network entity 2260 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a plurality of PDSCHs on a plurality of ports, each PDSCH of the plurality of PDSCHs being received through a different port of the plurality of ports, each PDSCH of the plurality of PDSCHs being received on a different set of non-overlapping REs within each RB of a set of RBs; and demodulating each PDSCH of a port based on DMRS received through the port.

Aspect 2 is the method of aspect 1, where each PDSCH of the plurality of PDSCHs is received on a different set of non-overlapping subcarriers within each RB of the set of RBs.

Aspect 3 is the method of aspect 2, where the plurality of ports comprises p ports, the set of non-overlapping subcarriers comprises n subcarriers, and the PDSCH for a particular port has a subcarrier gap of n(p−1) subcarriers.

Aspect 4 is the method of aspect 3, where n=1 and each PDSCH of the plurality of PDSCHs is received on a different subcarrier within each RB of the set of RBs.

Aspect 5 is the method of any of aspects 1 to 4, where each PDSCH of the plurality of PDSCHs is received on a different set of staggered non-overlapping REs within each RB of the set of RBs.

Aspect 6 is the method of aspect 5, where the different set of staggered non-overlapping REs comprises subsets of REs that are non-adjacent in time and frequency to each other.

Aspect 7 is the method of any of aspect 5, where the different set of staggered non-overlapping REs comprises REs that are non-adjacent in time and frequency to each other.

Aspect 8 is an apparatus for wireless communication for implementing any of aspects 1 to 7.

Aspect 9 is an apparatus for wireless communication including means for implementing any of aspects 1 to 7.

Aspect 10 is a computer-readable medium storing computer executable code, where the code when executed by a processor causes the processor to implement any of aspects 1 to 7.

Aspect 11 is a method of wireless communication at a network entity, including: transmitting a plurality of PDSCHs on a plurality of ports, each PDSCH of the plurality of PDSCHs being transmitted through a different port of the plurality of ports, each PDSCH of the plurality of PDSCHs being transmitted on a different set of non-overlapping REs within each RB of a set of RBs; receiving the transmitted PDSCHs reflected from one or more objects; and performing radar sensing for detecting the one or more objects based on the received reflected transmitted PDSCHs.

Aspect 12 is the method of aspect 11, where each PDSCH of the plurality of PDSCHs is transmitted on a different set of non-overlapping subcarriers within each RB of the set of RBs.

Aspect 13 is the method of aspect 12, where the plurality of ports comprises p ports, the set of non-overlapping subcarriers comprises n subcarriers, and the PDSCH for a particular port has a subcarrier gap of n(p−1) subcarriers.

Aspect 14 is the method of aspect 13, where n=1 and each PDSCH of the plurality of PDSCHs is transmitted on a different subcarrier within each RB of the set of RBs.

Aspect 15 is the method of any of aspects 11 to 14, where each PDSCH of the plurality of PDSCHs is transmitted on a different set of staggered non-overlapping REs within each RB of the set of RBs.

Aspect 16 is the method of aspect 15, where the different set of staggered non-overlapping REs comprises subsets of REs that are non-adjacent in time and frequency to each other.

Aspect 17 is the method of aspect 15, where the different set of staggered non-overlapping REs comprises REs that are non-adjacent in time and frequency to each other.

Aspect 18 is the method of any of aspects 11 to 17, further including receiving from a radar server beam direction information, wherein the plurality of PDSCHs are transmitted in beam directions based on the received beam direction information.

Aspect 19 is the method of any of aspects 11 to 18, further including receiving from a radar server PDSCH mapping information, wherein the plurality of PDSCHs are mapped to REs based on the PDSCH mapping information.

Aspect 20 is the method of any of aspects 11 to 19, further including transmitting, to a radar server, radar sensing results based on the performed radar sensing.

Aspect 21 is an apparatus for wireless communication for implementing any of aspects 11 to 20.

Aspect 22 is an apparatus for wireless communication including means for implementing any of aspects 11 to 20.

Aspect 23 is a computer-readable medium storing computer executable code, where the code when executed by a processor causes the processor to implement any of aspects 11 to 20.

Aspect 24 is a method of wireless communication at a UE, including: receiving a plurality of PDSCHs on a plurality of ports, each PDSCH of the plurality of PDSCHs being received through a different port of the plurality of ports, each PDSCH of the plurality of PDSCHs being received on a different RBG of a set of RBGs; de-interleaving the received PDSCHs based on a configured radar sensing interleaving pattern; and demodulating each de-interleaved PDSCH of a port based on DMRS received through the port.

Aspect 25 is an apparatus for wireless communication for implementing the aspect 24.

Aspect 26 is an apparatus for wireless communication including means for implementing the aspect 24.

Aspect 27 is a computer-readable medium storing computer executable code, where the code when executed by a processor causes the processor to implement the aspect 24.

Aspect 28 is a method of wireless communication at a base station, including: interleaving a plurality of PDSCHs based on a radar sensing interleaving pattern; transmitting, to a UE, a configuration indicating the radar sensing interleaving pattern; and transmitting, to the UE, the plurality of PDSCHs on a plurality of ports, each PDSCH of the plurality of PDSCHs being transmitted through a different port of the plurality of ports, each PDSCH of the plurality of PDSCHs being transmitted on a different RBG.

Aspect 29 is the method of aspect 28, further including receiving from a radar server beam direction information, wherein the plurality of PDSCHs are transmitted in beam directions based on the received beam direction information.

Aspect 30 is the method of any of aspects 28 and 29, further including receiving from a radar server PDSCH interleaving information, wherein the plurality of PDSCHs are interleaved based on the PDSCH interleaving information.

Aspect 31 is the method of any of aspects 28 to 30, further including: receiving the transmitted PDSCHs reflected from one or more objects; and performing radar sensing for detecting the one or more objects based on the received reflected transmitted PDSCHs.

Aspect 32 is the method of any of aspects 28 to 31, further including transmitting, to a radar server, radar sensing results based on the performed radar sensing.

Aspect 33 is an apparatus for wireless communication for implementing any of aspects 28 to 32.

Aspect 34 is an apparatus for wireless communication including means for implementing any of aspects 28 to 32.

Aspect 35 is a computer-readable medium storing computer executable code, where the code when executed by a processor causes the processor to implement any of aspects 28 to 32.

Aspect 36 is a method of wireless communication at a radar server, including: sending, to one or more network entities, PDSCH mapping information, the PDSCH mapping information corresponding to a plurality of PDSCHs on a plurality of ports and corresponding beam direction information, each PDSCH of the plurality of PDSCHs being through a different port of the plurality of ports, each PDSCH of the plurality of PDSCHs being on a different set of non-overlapping REs within each RB of a set of RBs; and receiving, from the one or more network entities in response to the transmitted PDSCH mapping information, radar sensing results.

Aspect 37 is the method of aspect 36, where each PDSCH of the plurality of PDSCHs is transmitted on a different set of non-overlapping subcarriers within each RB of the set of RBs.

Aspect 38 is the method of any of aspects 36 and 37, where the plurality of ports comprises p ports, the set of non-overlapping subcarriers comprises n subcarriers, and the PDSCH for a particular port has a subcarrier gap of n(p−1) subcarriers.

Aspect 39 is the method of any of aspects 36 to 38, where n=1 and each PDSCH of the plurality of PDSCHs is transmitted on a different subcarrier within each RB of the set of RBs.

Aspect 40 is the method of any of aspects 36 to 39, where each PDSCH of the plurality of PDSCHs is transmitted on a different set of staggered non-overlapping REs within each RB of the set of RBs.

Aspect 41 is the method of any of aspects 36 to 40, where the different set of staggered non-overlapping REs comprises subsets of REs that are non-adjacent in time and frequency to each other.

Aspect 42 is the method of any of aspects 36 to 41, where the different set of staggered non-overlapping REs comprises REs that are non-adjacent in time and frequency to each other.

Aspect 43 is an apparatus for wireless communication for implementing any of aspects 36 to 42.

Aspect 44 is an apparatus for wireless communication including means for implementing any of aspects 36 to 42.

Aspect 45 is a computer-readable medium storing computer executable code, where the code when executed by a processor causes the processor to implement any of aspects 36 to 42.

Aspect 46 is a method of wireless communication at a UE, including: sending, to one or more network entities, PDSCH mapping information, the PDSCH mapping information corresponding to PDSCH interleaving information based on a radar sensing interleaving pattern and to a plurality of PDSCHs being through a different port of the plurality of ports and corresponding beam direction information, each PDSCH of the plurality of PDSCHs being on a different RBG; and receiving, from the one or more network entities in response to the transmitted PDSCH interleaving information, radar sensing results.

Aspect 47 is an apparatus for wireless communication for implementing the aspect 46.

Aspect 48 is an apparatus for wireless communication including means for implementing the aspect 46.

Aspect 49 is a computer-readable medium storing computer executable code, where the code when executed by a processor causes the processor to implement the aspect 46.

What is claimed is:

1. A apparatus for wireless communication at a user equipment (UE), comprising:
a memory; and
at least one processor coupled to the memory and, based at least in part on information stored in the memory, the at least one processor is configured to:
receive a plurality of physical downlink shared channels (PDSCHs) on a plurality of ports, each PDSCH of the plurality of PDSCHs being received through a different port of the plurality of ports, each PDSCH of the plurality of PDSCHs being received on a different set of non-overlapping resource elements (REs) within each resource block (RB) of a set of RBs; and
demodulate each PDSCH of a port based on demodulation reference signals (DMRS) received through the port.

2. The apparatus of claim 1, wherein each PDSCH of the plurality of PDSCHs is received on a different set of non-overlapping subcarriers within each RB of the set of RBs.

3. The apparatus of claim 2, wherein the plurality of ports comprises p ports, each set of non-overlapping subcarriers comprises n subcarriers, and the PDSCH for a particular port has a subcarrier gap of n(p−1) subcarriers.

4. The apparatus of claim 3, wherein n=1 and each PDSCH of the plurality of PDSCHs is received on a different subcarrier within each RB of the set of RBs.

5. The apparatus of claim 1, wherein each PDSCH of the plurality of PDSCHs is received on a different set of staggered non-overlapping resource elements (REs) within each RB of the set of RBs.

6. The apparatus of claim 5, wherein the different set of staggered non-overlapping REs comprises subsets of REs that are non-adjacent in time and frequency to each other.

7. The apparatus of claim 5, wherein the different set of staggered non-overlapping REs comprises REs that are non-adjacent in time and frequency to each other.

8. The apparatus of claim 1, further comprising a transceiver coupled to the at least one processor.

9. A method of wireless communication at a user equipment (UE), comprising:
receiving a plurality of physical downlink shared channels (PDSCHs) on a plurality of ports, each PDSCH of the plurality of PDSCHs being received through a different port of the plurality of ports, each PDSCH of the plurality of PDSCHs being received on a different set of non-overlapping resource elements (REs) within each resource block (RB) of a set of RBs; and
demodulating each PDSCH of a port based on demodulation reference signals (DMRS) received through the port.

10. The method of claim 9, wherein each PDSCH of the plurality of PDSCHs is received on a different set of non-overlapping subcarriers within each RB of the set of RBs.

11. The method of claim 10, wherein the plurality of ports comprises p ports, each set of non-overlapping subcarriers comprises n subcarriers, and the PDSCH for a particular port has a subcarrier gap of n(p−1) subcarriers.

12. The method of claim 11, wherein n=1 and each PDSCH of the plurality of PDSCHs is received on a different subcarrier within each RB of the set of RBs.

13. The method of claim 9, wherein each PDSCH of the plurality of PDSCHs is received on a different set of staggered non-overlapping resource elements (REs) within each RB of the set of RBs.

14. The method of claim 13, wherein the different set of staggered non-overlapping REs comprises subsets of REs that are non-adjacent in time and frequency to each other.

15. The method of claim 13, wherein the different set of staggered non-overlapping REs comprises REs that are non-adjacent in time and frequency to each other.

16. A apparatus for wireless communication at a network entity, comprising:
a memory; and
at least one processor coupled to the memory and, based at least in part on information stored in the memory, the at least one processor is configured to:
transmit a plurality of physical downlink shared channels (PDSCHs) on a plurality of ports, each PDSCH of the plurality of PDSCHs being transmitted through a different port of the plurality of ports, each PDSCH of the plurality of PDSCHs being transmitted on a different set of non-overlapping resource elements (REs) within each resource block (RB) of a set of RBs;
receive the transmitted PDSCHs reflected from one or more objects; and
perform radar sensing for detecting the one or more objects based on the received reflected transmitted PDSCHs.

17. The apparatus of claim 16, wherein each PDSCH of the plurality of PDSCHs is transmitted on a different set of non-overlapping subcarriers within each RB of the set of RBs.

18. The apparatus of claim 17, wherein the plurality of ports comprises p ports, each set of non-overlapping subcarriers comprises n subcarriers, and the PDSCH for a particular port has a subcarrier gap of n(p−1) subcarriers.

19. The apparatus of claim 18, wherein n=1 and each PDSCH of the plurality of PDSCHs is transmitted on a different subcarrier within each RB of the set of RBs.

20. The apparatus of claim 16, wherein each PDSCH of the plurality of PDSCHs is transmitted on a different set of staggered non-overlapping resource elements (REs) within each RB of the set of RBs.

21. The apparatus of claim 20, wherein the different set of staggered non-overlapping REs comprises subsets of REs that are non-adjacent in time and frequency to each other.

22. The apparatus of claim 20, wherein the different set of staggered non-overlapping REs comprises REs that are non-adjacent in time and frequency to each other.

23. The apparatus of claim 16, wherein the at least one processor is further configured to receive from a radar server beam direction information, wherein the plurality of PDSCHs are transmitted in beam directions based on the received beam direction information.

24. The apparatus of claim 16, wherein the at least one processor is further configured to receive from a radar server PDSCH mapping information, wherein the plurality of PDSCHs are mapped to REs based on the PDSCH mapping information.

25. The apparatus of claim 16, wherein the at least one processor is further configured to transmit, to a radar server, radar sensing results based on the performed radar sensing.

26. The apparatus of claim 16, further comprising a transceiver coupled to the at least one processor.

27. The apparatus of claim 16, wherein the network entity is a base station or a component of the base station.

28. A apparatus for wireless communication at a user equipment (UE), comprising:
a memory; and
at least one processor coupled to the memory and, based at least in part on information stored in the memory, the at least one processor is configured to:
receive a plurality of physical downlink shared channels (PDSCHs) on a plurality of ports, each PDSCH of the plurality of PDSCHs being received through a different port of the plurality of ports, each PDSCH of the plurality of PDSCHs being received on a different resource block group (RBG) of a set of RBGs;
de-interleave the received PDSCHs based on a configured radar sensing interleaving pattern; and
demodulating each de-interleaved PDSCH of a port based on demodulation reference signals (DMRS) received through the port.

29. The apparatus of claim 28, wherein the PDSCHs are interleaved based on rectangular interleaving pattern.

30. The apparatus of claim 28, further comprising a transceiver coupled to the at least one processor.
